(19) United States
(12) Patent Application Publication
(10) Pub. No.: US 2026/0050960 A1
(43) Pub. Date: Feb. 19, 2026

(54) SYSTEMS AND METHODS OF SELECTING AN AIR CONDITIONING SYSTEM AND METHODS OF TRAINING MODELS USED IN THESE SYSTEMS AND METHODS

(71) Applicant: Munters Europe Aktiebolag, Kista (SE)

(72) Inventor: Magnus Carlsson, Vallentuna (SE)

(21) Appl. No.: 18/806,968

(22) Filed: Aug. 16, 2024

(51) Int. Cl. G06Q 30/0601; G06N 20/00

(52) U.S. Cl. CPC G06Q 30/0629; G06N 20/00

(57) ABSTRACT

A method of selecting an air conditioning system utilizing one or more artificial-intelligence-based models and methods of training the one or more artificial-intelligence-based models. The one or more artificial-intelligence-based models can be used to select one or more air conditioning systems based on a usage input and output results reflecting the selected at least one air conditioning system. Selecting the at least one air conditioning system can include selecting two or more air conditioning systems from a plurality of different air conditioning systems and generating a narrative comparing the selected two or more air conditioning systems. The one or more artificial-intelligence-based models can include an application model, an optimization model, and a generative comparison model.

### FIELD OF THE INVENTION

The invention relates to systems and methods for selecting air conditioning systems, particularly rotary-based sorbent conditioning systems, such as desiccant dehumidifiers, for a particular application.

### BACKGROUND OF THE INVENTION

Commercial and industrial scale air conditioning systems are used in a wide variety of applications. Some such air conditioning systems use a sorbent to remove various molecules from an airstream to condition the airstream. The sorbents may be arranged in a rotor to rotate between various zones, such as a process zone where the sorbent removes molecules from process air flowing through the sorbent in the process zone and a regeneration zone where a regeneration airstream removes the molecules from the sorbent to regenerate the sorbent. One example is dehumidification, where the sorbent is a desiccant and the desiccant is used to remove water, such as water vapor, from the process air.

### SUMMARY OF THE INVENTION

In one aspect, the invention relates to a method of selecting an air conditioning system. The method can be a computer-implemented method executed by one or more processors utilizing one or more artificial-intelligence-based models to select one or more air conditioning systems based on a usage input and output results reflecting the selected at least one air conditioning system. In some aspects, selecting the at least one air conditioning system includes selecting two or more air conditioning systems from a plurality of different air conditioning systems and generating a narrative comparing the selected two or more air conditioning systems.

In another aspect, the invention relates to a method of selecting an air conditioning system. The method is a computer-implemented method executed by one or more processors. The method includes receiving a plurality of usage inputs including an application, an application size, and an air parameter; determining, using an application model, a plurality of input air conditions and a plurality of output air conditions for the application based on the plurality of usage inputs; calculating, using a selection module, system parameters for a plurality of different air conditioning systems; and selecting, using an optimization model, at least one air conditioning system from the plurality of different air conditioning systems. The optimization model selects the at least one air conditioning system using the system parameters for the plurality of different air conditioning systems based on one or more optimization targets. The application model is an artificial-intelligence-based model, and the optimization model is an artificial-intelligence-based model. The method also can include outputting results reflecting the selected at least one air conditioning system.

In some aspects, selecting the at least one air conditioning system includes selecting two or more air conditioning systems from the plurality of different air conditioning systems using the optimization model. The optimization model selects the two or more air conditioning systems from the plurality of different air conditioning systems using the system parameters for the plurality of different air conditioning systems based on the one or more optimization targets. The method can further include generating, using a generative comparison model, a narrative comparing the selected two or more air conditioning systems, and outputting the results includes outputting the two or more air conditioning systems with the narrative. The generative comparison model is an artificial-intelligence-based model.

In a further aspect, the invention relates to a method of generating an application model for selecting an air conditioning system. The method includes receiving training data comprising a plurality of applications, each application of the plurality of applications having an application size, an output air parameter, and at least one of a plurality of input air conditions or a plurality of output air conditions; and training the application model using the training data to correlate the application, the application size, the input air parameter, and the output air parameter, with the at least one of the plurality of input air conditions or the plurality of output air conditions. The application model is an artificial-intelligence-based model.

In still another aspect, the invention relates to a method of generating an optimization model for selecting an air conditioning system. The method includes receiving training data comprising an air conditioning system size and resource requirements for a plurality of different air conditioning systems; and training the optimization model using the training data to select two or more air conditioning systems from the plurality of different air conditioning systems using the air conditioning system size and resource requirements based on one or more optimization targets. The optimization model is an artificial-intelligence-based model.

These and other aspects of the invention will become apparent from the following disclosure.

### BRIEF DESCRIPTION OF THE DRAWINGS

FIG. 1 is a schematic diagram of an air conditioning selection system in accordance with an embodiment.

FIG. 2 is a schematic block diagram illustrating aspects of the computer-implemented methods used to select at least one air conditioning system for a particular application.

FIG. 3 is a flow chart for a method of selecting an air conditioning system.

FIG. 4 is a schematic block diagram illustrating aspects of the computer-implemented methods used to select at least one air conditioning system for a particular application.

FIG. 5 is a flow chart for a method of selecting an air conditioning system.

FIG. 6 is a schematic block diagram illustrating aspects of the computer-implemented methods used to select at least one air conditioning system for a particular application.

FIG. 7 is a flow chart for a method of selecting an air conditioning system.

FIG. 8 is a schematic diagram of a computing device (or computing system) that may be used to implement the air conditioning selection system.

### DETAILED DESCRIPTION OF THE PREFERRED EMBODIMENTS

Features and advantages of the present disclosure will be apparent from the following description of various exemplary embodiments, as illustrated in the accompanying drawings. In these drawings, like reference numbers generally indicate identical, functionally similar, and/or structurally similar elements, and unless otherwise indicated, the description of a feature in one figure applies to other figures and embodiments containing that element even if a detailed description of that element is omitted from the accompanying description.

Fluid conditioning systems include one or more fluid conditioning units that are used to condition a fluid, such as air (i.e., an air conditioning system with one or more air conditioning units). In embodiments discussed herein, the fluid conditioned is air, but the disclosure may be applied to other fluid conditioning systems and fluid conditioning units, such as fluid conditioning systems and fluid conditioning units that condition liquids such as water. Also, the air conditioning processes in embodiments discussed herein relate to dehumidification, but the disclosure may be applied to other air (or fluid) conditioning systems that implement other air (or fluid) conditioning processes, such as those that heat or cool the fluid, or remove unwanted compounds from the fluid, such as, but not limited to, carbon dioxide and volatile organic compounds.

As noted above, commercial and industrial scale air conditioning systems, such as dehumidification systems, are used in a wide variety of applications. Such dehumidification systems may be used, for example, to control the environment in which a product, such as a pharmaceutical or a food product, is produced to maintain the quality of the product during the manufacturing process. Other industrial dehumidification systems are used directly as part of a manufacturing process, where, for example, the product being produced undergoes a drying or dehumidification step. In some manufacturing processes, the product needs to be produced in an environment that is separated from ambient conditions, creating large transient heat and moisture loads. In other processes, the process may produce moisture that needs to be evacuated in order to maintain product safety under steady low moisture load. Other examples of applications for such dehumidification systems include industrial, commercial, residential, retail, and institutional buildings such as supermarkets, hotels, research laboratories, and hospitals. Further examples include maintaining the air in warehouses storing various goods. Some such warehouse applications may be relatively “passive” storage applications where individuals are not typically working in the warehouse, but others may be “active” where, for example, forklifts move product in and out all day long, creating large transient heat and moisture loads.

This wide variety of applications also results in a wide variety of heat loads, moisture loads, and required air handling capacity. The owners and operators of these facilities may not have an in-depth understanding of such loads and capacity. Instead, these owners and operators have an understanding of the intended application, such as the manufacturing process or the type of facility in which the air conditioning system will be used. These owners and operators also have an understanding of the application size, either in terms of a manufacturing capacity or other factor related to facility size, such as volume or area. In some instances, the owners and operators may have some target condition for the air, such as a target humidity or temperature. The systems and methods discussed can be used to identify input air conditions, output air conditions, and other factors that can then be used to determine the appropriate air conditioning systems for the specific application.

In many instances, there are different air conditioning systems, both those made by the same company and those made by competing companies, that may provide a satisfactory solution for the intended application. Yet, some air conditioning systems may be better suited to a particular application or provide certain advantages over other systems. The systems and methods discussed herein can be used to select suitable air conditioning systems for a particular application and identify various advantages and disadvantages of such systems, and then present the selected systems and the various advantages and disadvantages to an individual, such as the owner or operator. In some embodiments, the systems and methods discussed herein make use of artificial intelligence (AI)-based models, such as machine learning (ML)-based models.

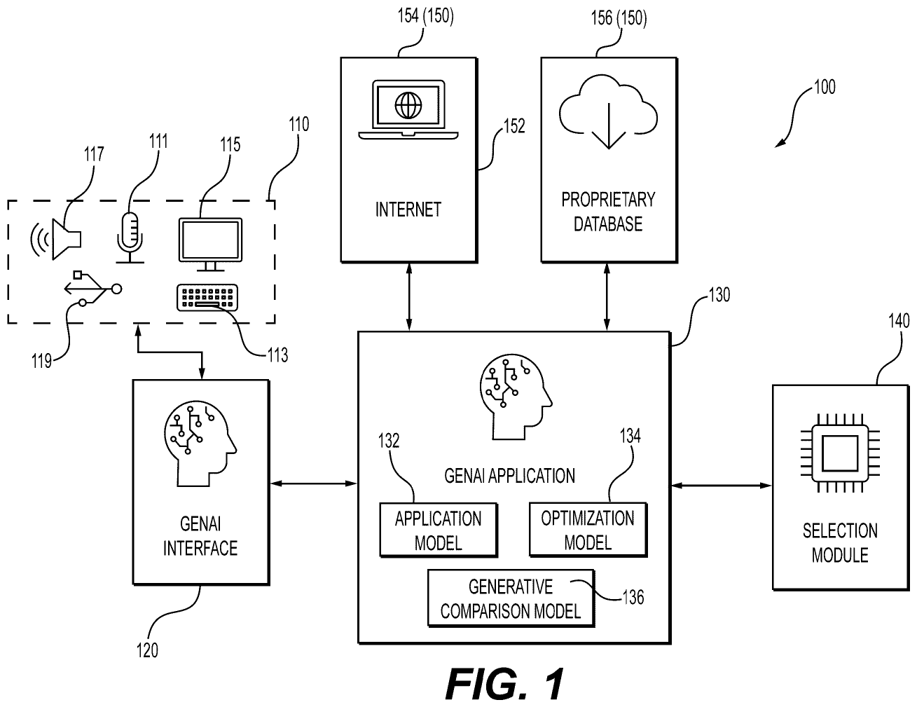

FIG. 1 is a schematic diagram of an air conditioning selection system 100 in accordance with an embodiment. The air conditioning selection system 100 can be implemented using one or more computing devices, discussed further below, having one or more processors and one or more memories. The memory can store information accessible by the processor, including computer-readable instructions that can be executed by the processor. The instructions can be any set of instructions or a sequence of instructions that, when executed by the processor, causes the processor and the controller to perform operations. In some embodiments, the instructions can be executed by the processor to cause the processor to complete any of the operations and functions for which the controller is configured, as will be described further below. The instructions can be software written in any suitable programming language or can be implemented in hardware. Additionally and/or alternatively, the instructions can be executed in logically and/or virtually separate threads on the processor. The memory can further store data that can be accessed by the processor.

The air conditioning selection system 100 can be used to execute and implement the computer-implemented methods discussed further below. The following discussion will provide a general overview of the air conditioning selection system 100, and additional details of the air conditioning selection system 100 will be discussed further below in connection with the discussion of the computer-implemented methods. The air conditioning selection system 100 can include one or more user input devices or one or more user output devices, allowing the user to interact with the air conditioning selection system 100. In some embodiments, the air conditioning selection system 100 includes both a user input device and a user output device. Some devices can be both a user input device and a user output device. The user input devices and user output devices are collectively referred to herein as user input/output devices 110. The air conditioning selection system 100 can receive various inputs from a user through the user input/output devices 110. These inputs can include, for example, a text input, a graphics input, or an audio input. The air conditioning selection system 100 can also generate various outputs that are provided to the user through the user input/output devices 110. These outputs can include, for example, a text output, a graphics output, or an audio output.

The user input/output devices 110 can include, for example, a microphone 111 for receiving an audio input such as speech. Other user input/output devices 110 can include a keyboard 113, whether physical or virtual, for receiving the text input. The user input/output devices 110 also can include a display 115 to display the text output or the graphics output of the air conditioning selection system 100. In some embodiments, the display 115 can be a touchscreen display with user-selectable elements, such as virtual buttons or icons, displayed thereon to receive an input from the user. The user input/output devices 110 can also include a speaker 117 to provide an audio output. These inputs and outputs may be received or transmitted directly by the air conditioning selection system 100. Such inputs and outputs may be received or transmitted indirectly via data transmitted through one or more communications interfaces 119, such as a port or wireless transmitter or receiver.

In some embodiments, particularly where the user input is received directly and the output is provided directly to the user, the air conditioning selection system 100 can include a natural language translation engine communicatively coupled to the user input/output devices 110 to receive the input and, as discussed further below, generate a plurality of usage inputs. The natural language translation engine can be an AI-based engine or AI-based model and is referred to herein as a generative AI interface 120 (GenAI interface). The generative AI interface 120 can receive an input comprising a natural language input and generate particular inputs that can be used in the computer-implemented methods discussed herein and, more specifically, the plurality of usage inputs. The generative AI interface 120 is communicatively coupled to a generative AI application 130 (GenAI application) to provide the plurality of usage inputs to the generative AI application 130. The generative AI interface 120 is also communicatively coupled to the generative AI application 130 to receive outputs from the generative AI application 130. The generative AI interface 120 can also be configured to generate an output including a natural language output for the user, and thus can be communicatively coupled to the user input/output devices 110 to provide the natural language output to the user in a manner corresponding to the particular user input/output device 110. For example, the output can be an audio output consisting of natural language speech that is output using the speaker 117 or a text-based output in natural language that is displayed on the display 115.

As noted above, the air conditioning selection system 100 includes a generative AI application 130. The generative AI application 130 is used to execute the computer-implemented methods discussed below. The generative AI application 130 can include one or more AI-based models. The following discussion will refer to three different models: an application model 132, an optimization model 134, and a generative comparison model 136. Although described in the following discussion as three different models, the features, functions, or configurations of these models can be combined into fewer models or split into additional models. The generative AI application 130 or the models included therein can also include additional instructions saved on a memory to carry out the computer-implemented methods discussed below. While, generally, such aspects are described as being carried out by the generative AI application 130, this is done for simplicity and each step may be carried out separately as part of another module.

As will be discussed in more detail below, the computer-implemented methods include methods used to select one or more air conditioning systems from a plurality of different air conditioning systems for a particular application. The particular application is identified using the inputs into the generative AI application 130. As noted above, the generative AI application 130 can be communicatively coupled to the generative AI interface 120, and in some embodiments the inputs are provided via the generative AI interface 120. The generative AI application 130 can be used to refine, determine, or define the application in more detail and determine a plurality of air conditions for the application.

The generative AI application 130 also can be communicatively coupled to a selection module 140. The selection module 140 can include thermodynamic models for each of the plurality of different air conditioning systems. Using the thermodynamic models, the selection module 140 can determine, calculate, or both, system parameters for each of the plurality of different air conditioning systems based on the plurality of air conditions. The system parameters can include air conditioning system size and resource requirements for each of the plurality of different air conditioning systems. The generative AI application 130 can provide the plurality of air conditions for the application to the selection module 140, and the generative AI application 130 can receive the system parameters, such as the air conditioning system size and resource requirements, for each of the plurality of different air conditioning systems. The generative AI application 130 can receive the air conditioning system size and resource requirements for the plurality of different air conditioning systems and select the at least one air conditioning system using the air conditioning system size and resource requirements for the plurality of different air conditioning systems based on one or more optimization targets.

The generative AI application 130 also can be communicatively coupled to various data sources 150. These data sources 150 can include various data sources that can be accessed via the internet 152, and are referred to herein as internet data sources 154. These internet data sources 154 can be publicly available data sources or other databases available through the internet. The data sources 150 can also include data sources that are available via other networks, such as other databases including a proprietary database 156. As will be detailed further below, data sources 150 can be used by the generative AI application 130 to define, determine, or refine the one or more optimization targets or other factors used to select the at least one air conditioning system.

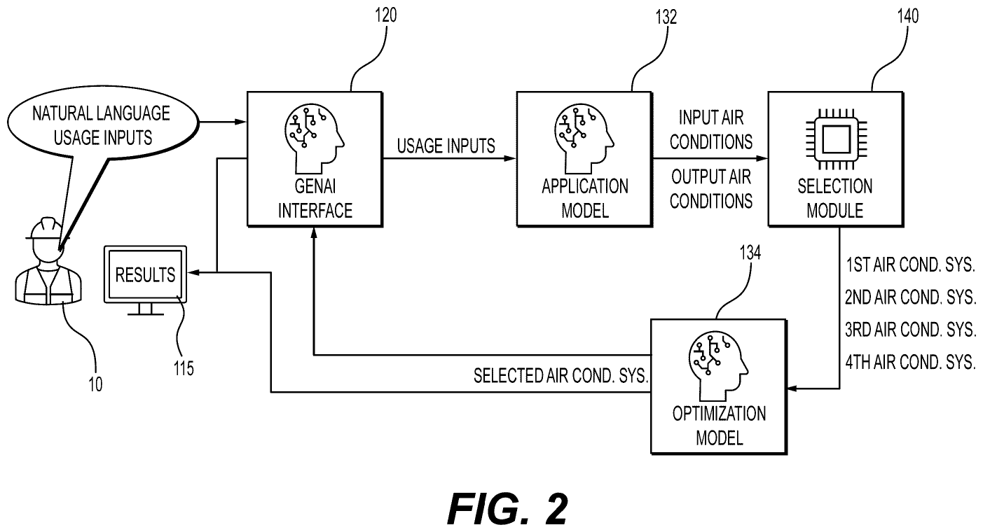

FIG. 2 is a schematic block diagram illustrating aspects of the computer-implemented methods used to select at least one air conditioning system for a particular application. A user 10 of the system, such as an owner or operator of facilities desiring air conditioning, can provide a question or query to the air conditioning selection system 100, such as through the user input/output devices 110. The user 10 can also be a sales representative for the producer, manufacture, or supplier of air conditioning. More specifically, the user 10 can provide a usage input. When the generative AI interface 120 is used, the usage input can be a natural language input, and the generative AI interface 120 receives the natural language usage input and generates the usage input to be subsequently provided to the generative AI application 130. The usage input can include one or more of an application, an application size, or an air parameter. The usage input also can include a location, such as a geographical location. Additionally or alternatively, the usage input can include target parameters for the air conditioning system, including, for example, target parameters for the air being input into the air conditioning system, target parameters for the air being output from the air conditioning system, target energy use, and target footprint of the air conditioning system (e.g., volume or area used by the air conditioning system). The user 10 can also provide other user expressed values, such as values relating to or characterizing the other usage parameters. Other user expressed values may include preferred or desired factors and conditions for the selected air conditioning system. In some embodiments, a plurality of usage inputs can be used, including each of the application, the application size, and the air parameter.

When the air conditioning system being selected includes a dehumidification system, the applications can include, for example, battery manufacturing, storage (e.g., warehouse), food production, and pharmaceutical production. Storage can also include storage for particular products, such as food storage, cold storage, and the like. Other applications can include, defense facilities, universities, test facilities, such as those where air conditions need to be controlled, and construction facilities like bridges.

The application size can be used to determine volumetric flow rates of the air that the air conditioning system will need to provide for the desired application. The application size can include a building size, such as a volume, for example. When the application is a warehouse, the application size can be a volume of the storage space. The application size can include, however, other non-volumetric parameters, such as the following examples. When the application is a manufacturing process, the application size can be a manufacturing capacity. For example, the manufacturing capacity of a battery manufacturing application can be gigawatt-hours constructed per year. Additionally or alternatively, the application size can include building type. For example, if the application is a battery plant, the building type can be a further indicator relative to the scale of the plant, such as a lab facility as opposed to a full-size battery production facility (e.g., a gigafactory).

The air parameter can be a parameter of the air being conditioned. The air parameter can be an input air parameter related to the air being input into the air conditioning system or an output air parameter related to the air being output from the air conditioning system. In some embodiments, such as where the air conditioning system is a dehumidification system, the air parameter can be critical adsorption parameters such as a target humidity of the output air or input air, a target temperature of the output air or input air, or both. While specific thermodynamic properties of the air can be used, other indicators of such conditions may be used as the air parameter. For example, where the air input into the air conditioning system is ambient air, the input air parameter can include a location of the application.

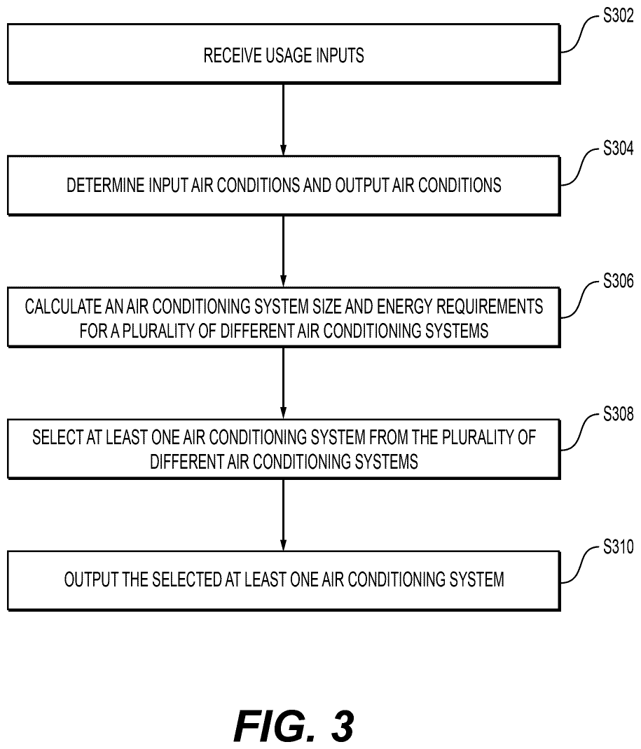

FIG. 3 is a flow chart for a method of selecting an air conditioning system. The method is a computer-implemented method executed using the air conditioning selection system 100 discussed above with reference to FIG. 1 and schematically illustrated in FIG. 2. Referring to both FIGS. 2 and 3, the generative AI application 130 and, more specifically, application model 132 receives, in step S302, the plurality of usage inputs. When used, the generative AI interface 120 provides the plurality of usage inputs to the application model 132. As noted above, the plurality of usage inputs are not necessarily thermodynamic parameters that can be used by the selection module 140 to determine an air conditioning system size and energy requirements for a plurality of different air conditioning system requirements. The application model 132 is used in step S304 to determine a plurality of input air conditions and a plurality of output air conditions for the application. The application model 132 can be an AI-based model, such as an ML-based model, that has been trained to determine from the usage parameters the input air conditions and the output air conditions for the application.

When the application model 132 is a trained ML-based model, the application model 132 can be trained using training data. For clarity with other training data discussed herein, the training data used to train the application model 132 is referred to herein as application training data. The application training data can include a plurality of applications, each application of the plurality of applications having an application size, an output air parameter, and at least one of a plurality of input air conditions or a plurality of output air conditions. In some embodiments, the application training data can include a plurality of locations and temperature and humidity data at each one of the plurality of locations. As used herein locations, more specifically, different geographical locations, are different when they are separated by 150 km or more. Preferably the geographical locations are in different climates using, for example, the Köppen Classification System and/or have different average seasonal atmospheric conditions.

The application model 132 provides the input air conditions and the output air conditions for the application to the selection module 140, and the selection module 140 receives the input air conditions and the output air conditions for the application. Then in step S306, the selection module 140 calculates system parameters for a plurality of different air conditioning systems. The different air conditioning systems may be different models of air conditioning systems. These different models could be produced by the same manufacturer or supplier, be produced by different manufacturers or suppliers, or both. For example, the selection module 140 can calculate system parameters for each of a first air conditioning system, a second air conditioning system, a third air conditioning system, and a fourth air conditioning system. In some embodiments, all four of the air conditioning systems may be produced by the same manufacturer, but be different models or variants of the air conditioning systems. In other embodiments, one or more of the air conditioning systems is produced by a first manufacturer (e.g., the first air conditioning system and the second air conditioning system), and one or more of the air conditioning systems is produced by a second manufacturer (e.g., the third air conditioning system and the fourth air conditioning system). The first manufacturer may be a proprietor of the air conditioning selection system 100, and the second manufacturer may be a competitor of the proprietor. Two manufacturers and four air conditioning systems are used in these examples for simplicity, but in practice, many more air conditioning systems, manufacturers, or both could be evaluated using the air conditioning selection system 100.

As noted above, the selection module 140 calculates system parameters for each of the plurality of different air conditioning systems (e.g., system parameters for each of the first air conditioning system, the second air conditioning system, the third air conditioning system, and the fourth air conditioning system). As will be discussed in more detail below, these system parameters can be parameters that the optimization model 134 will use to select one or more of the air conditioning systems from the plurality of different air conditioning systems. One criterion (or optimization target) that may be used by the optimization model 134 during the selection process is cost. This cost could be an upfront cost to procure and install the air conditioning system (e.g., an initial capital expenditure or an initial cost of purchasing), a total cost of ownership, or both. To determine the total cost of ownership, the selection module 140, the optimization model 134, or both may calculate or otherwise determine an expected life cycle cost for the air conditioning system. Resource requirements can be used, for example, to determine the expected life cycle cost. The selection module 140 can calculate these resource requirements over various time periods and extrapolate such resource requirements for the estimated life of the system. For example, the selection module 140 can calculate the expected energy usage and, more specifically, electricity usage in, for example, megawatthours for a time period, such as per year, and then extrapolate this value over the life of the system. The resource requirements are not limited to electricity usage, but may include other resource requirements. For example, some air conditioning systems can have heaters that burn combustible fuels, such as natural gas, and the resource requirements can include the volume of combustible fluid consumed per year. Steam can also be used for heating and the source requirements can include the volume of steam used per year. In another example, some air conditioning systems use evaporative cooling or another system that uses water, and the resource requirements can include the volume of water consumed per year. These resource requirements can be used as an optimization target apart from a cost calculation, such as, for example, in an efficiency in conditioning the air (e.g., energy used to remove a compound like water from the air (kWh/kg)).

A further optimization target can be the footprint of the air conditioning system (e.g., volume or area used by the air conditioning system). The optimization target can be set to minimize the footprint or to limit the footprint to no more than a threshold size. The selection module 140 can also determine the footprint as part of the system parameters.

The selection module 140 transmits the system parameters to the optimization model 134, and the optimization model 134 receives the system parameters. In step S308, the optimization model 134 selects at least one air conditioning system from the plurality of different air conditioning systems. The optimization model 134 selects the at least one air conditioning system using selection criteria, such as optimization targets. The optimization model 134 selects the at least one air conditioning system based on one or more optimization targets. The optimization model 134 can be an AI-based model, such as an ML-based model, that has been trained to select the at least one air conditioning system using system parameters, such as the air conditioning system size and resource requirements, and based on the optimization targets or other selection criteria. As will be discussed further below, the optimization model 134 can be an AI-based model, such as an ML-based model, that has been trained to select the two or more air conditioning systems using system parameters, such as the air conditioning system size and resource requirements, and based on the optimization targets or other selection criteria.

When the optimization model 134 is a trained ML-based model, the optimization model 134 can be trained using training data. For clarity with other training data discussed herein, the training data used to train the optimization model 134 is referred to herein as optimization training data. The optimization training data can include the air conditioning system size and resource requirements for a plurality of different air conditioning systems. In some embodiments, one of the plurality of different air conditioning systems is an air conditioning system of a first manufacturer, such as the proprietor, and another one of the plurality of air conditioning systems is an air conditioning system of a second manufacturer, such as a competitor.

The method includes outputting results reflecting the selected at least one air conditioning system in step S310. As illustrated in FIG. 2, the results may be output using the user input/output devices 110, such as by being displayed on a display 115. In some embodiments, the optimization model 134 may directly output the results using the user input/output devices 110, but in other embodiments, the optimization model 134 transmits the selected at least one air conditioning system to the generative AI interface 120, and the generative AI interface 120 generates a natural language output that can be used to convey the results to the user 10. In such an embodiment, the results can be conveyed as a natural language output as a text output or an audio output, for example.

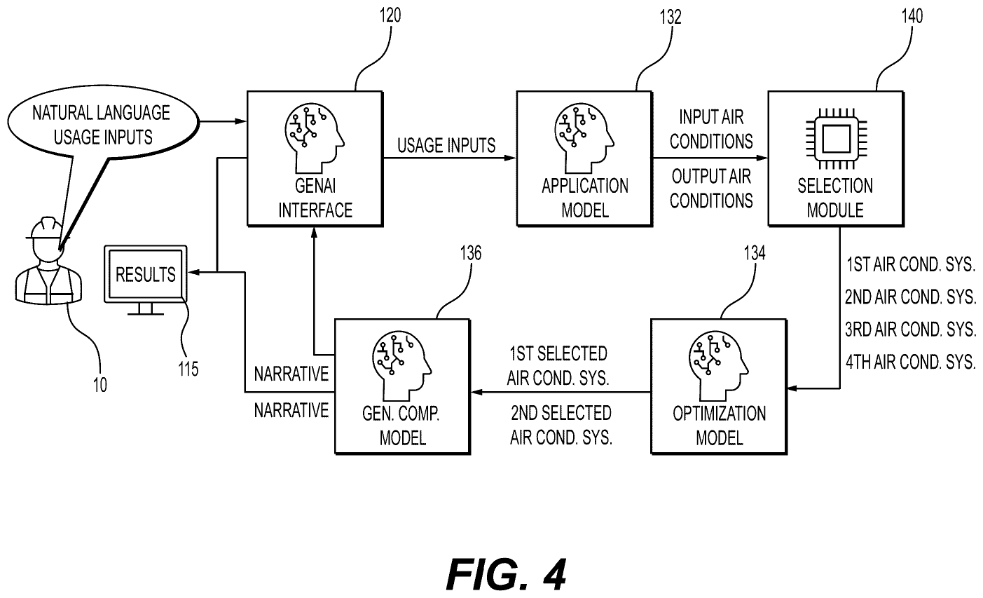

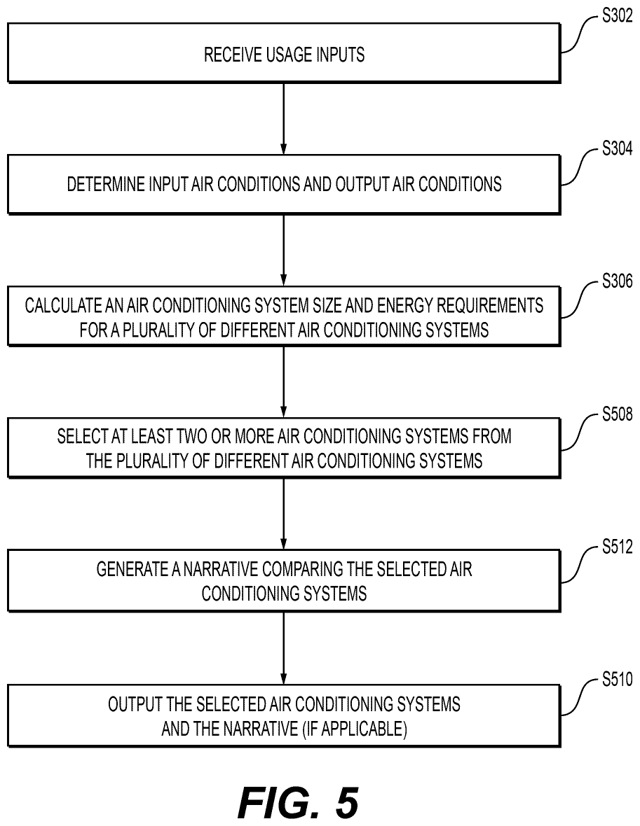

The air conditioning selection system 100 can be used to select one air conditioning system from the plurality of different air conditioning systems. The air conditioning selection system 100 can be advantageously used to select two or more air conditioning systems from the plurality of different air conditioning systems. FIG. 4 is a schematic block diagram illustrating aspects of the computer-implemented methods used to select two or more air conditioning systems for a particular application, and FIG. 5 is a flow chart for a method of selecting two or more air conditioning systems. The computer-implemented methods illustrated and described with reference to FIGS. 4 and 5 are similar to the computer-implemented methods illustrated and described above with reference to FIGS. 2 and 3, and the discussion above applies here.

Step S508 is similar to step S308 in FIG. 3, but in this step the optimization model 134 selects two or more air conditioning systems from the plurality of different air conditioning systems using the system parameters for the plurality of different air conditioning systems based on the selection criteria, such as one or more optimization targets. The selected one or more air conditioning systems from the plurality of different air conditioning systems may be referred to herein as product alternatives. As will be discussed in more detail below, the optimization targets may balance competing factors, and there may be multiple air conditioning systems that may be acceptable for a particular application. The optimization model 134 can be used to select two or more air conditioning systems from the plurality of different air conditioning systems and output, in step S510, the selected air conditioning systems in a manner similar to step S310, discussed above.

The method shown in FIG. 5 also can include in step S512 generating a narrative, using the generative comparison model 136, to compare the selected air conditioning systems (e.g., the product alternatives). The narrative can also be output in step S510 in a manner similar to the way the results are output in step S310, discussed above.

The narrative can compare various advantages and disadvantages of the product alternatives. The narrative can compare an upfront cost to procure and install each of the product alternatives. The narrative can compare a total cost of ownership of each of the product alternatives. The narrative can compare the resource requirements of each of the product alternatives.

As noted above, one of the two or more air conditioning systems can be an air conditioning system of a first manufacturer, such as a proprietor, and another one of the two or more air conditioning systems can be an air conditioning system of a second manufacturer, such as a competitor. The narrative can compare the air conditioning system of the first manufacturer (e.g., of the proprietor) with the air conditioning system of the second manufacturer (e.g., of the competitor). In such embodiments, the generative comparison model 136 can be trained to promote the air conditioning system of the proprietor relative to the air conditioning system of the competitor. The generative comparison model 136 can be trained to emphasize drawbacks of the air conditioning system of the competitor relative to the air conditioning system of the proprietor. The generative comparison model 136 can be trained to generate a narrative providing benefits of the air conditioning system of the proprietor relative to the air conditioning system of the competitor.

When the generative comparison model 136 is a trained ML-based model, the generative comparison model 136 can be trained using training data. For clarity with other training data discussed herein, the training data used to train the generative comparison model 136 is referred to herein as narrative training data. In some embodiments, the narrative training data can include various comparative evaluations between different systems including the different systems discussed above (e.g., proprietor systems and competitor systems). In some embodiments, the generative comparison model 136 can be an existing language model that is further trained (or tuned) using the narrative training data or through a training process that includes reinforcement learning, such as reinforcement learning from human feedback (RLHF). Existing language models can include, for example, large language models such as OpenAI's GPT series of models, Google's Gemini, Meta's LLamA family of models, and the like.

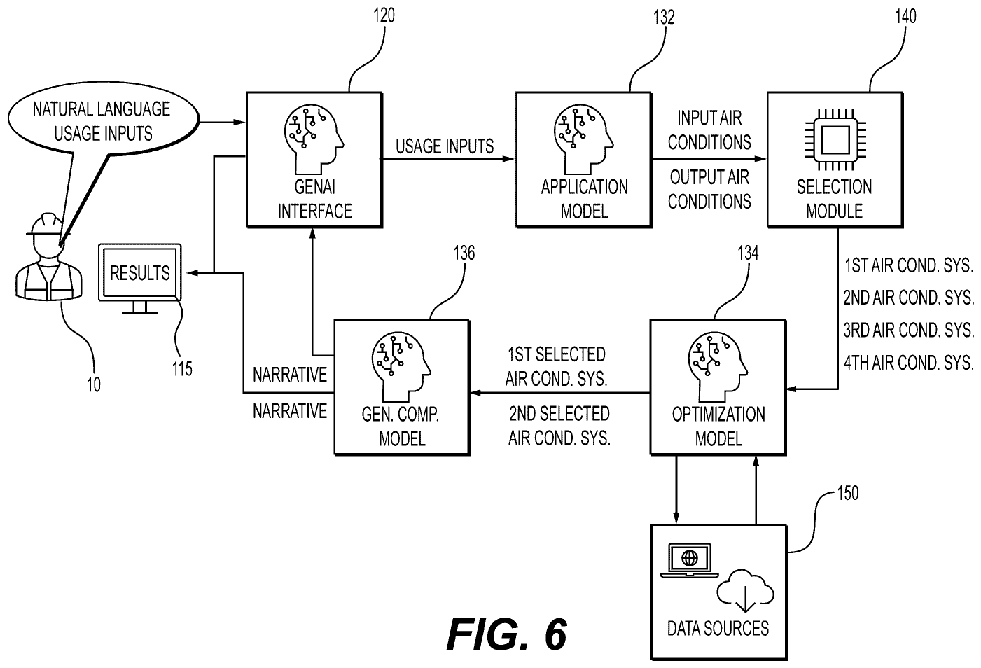

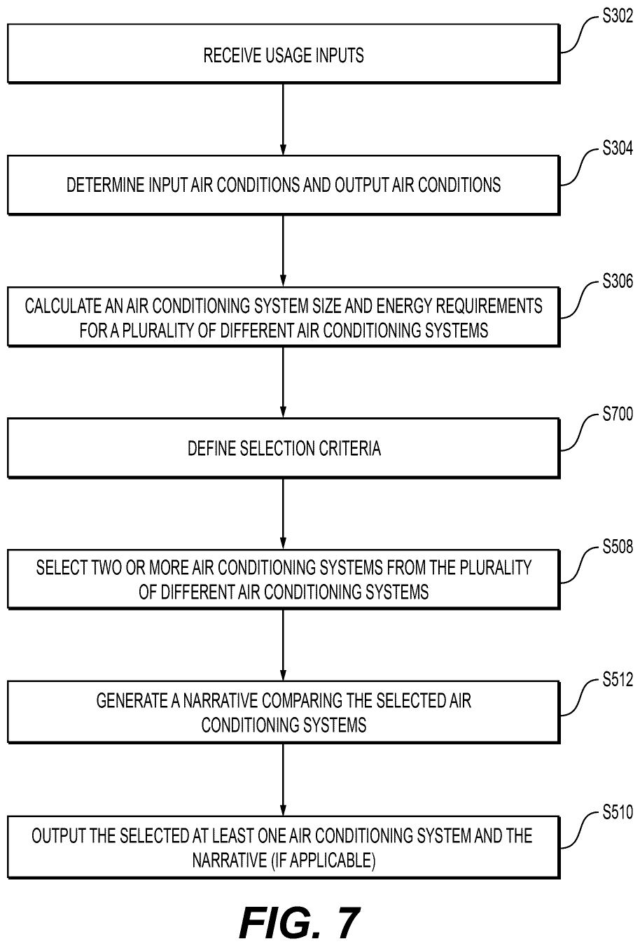

FIG. 6 is a schematic block diagram illustrating aspects of the computer-implemented methods used to select two or more air conditioning systems for a particular application, and FIG. 7 is a flow chart for a method of selecting two or more air conditioning systems. The computer-implemented methods illustrated and described with respect to FIGS. 6 and 7 are similar to the computer-implemented methods illustrated and described above with reference to FIGS. 4 and 5 and the discussion above applies here. The method shown and described with respect to FIGS. 6 and 7 includes the additional step (step S700) of defining the selection criteria, such as the optimization targets. In some embodiments, the selection criteria may be specific criteria input into the optimization model 134, but in other embodiments, the optimization model 134 may be trained using training data. For clarity with other training data discussed herein, the training data used to train the optimization model 134 to define the selection criteria is referred to herein as selection criteria training data. Training the optimization model 134 can be done in conjunction with training the optimization model 134 to select one or more of the plurality of different air conditioning systems, and in these embodiments, the optimization training data can include the selection criteria training data. The selection criteria training data can include the selection strategies of the proprietor and/or the selection strategies of the competitor.

While defining the selection criteria, such as the optimization targets, can be done in advance by training the optimization model 134, the optimization model 134 can be updated or retrained periodically or during each use, and step S700 can be executed during the method. Step S700 can be a step of retraining the optimization model 134. In one example, when the input provided by the user 10 includes user-expressed values, the user-expressed values may be goals or other desired factors of the air conditioning system and the user-expressed values thus can be used to define the selection criteria. These user-expressed values can be selection criteria training data used to retrain or tune the optimization model 134.

As noted above, the generative AI application 130 and, more specifically, the optimization model 134 can be communicatively coupled to the data sources 150. The optimization model 134 can be retrained or tuned by accessing selection criteria training data from the data sources 150. As noted above, the data sources 150 can include internet data sources 154 that can be accessed via internet 152. Step S700 can include searching one or more internet data sources 154 for data related to air conditioning systems. The data related to air conditioning systems can include regulatory data. Step S700 can include searching one or more internet data sources 154 for publicly available data related to air conditioning system selection strategies of the competitor. This searching can enable the optimization model 134 or the generative comparison model 136 to identify a trend derived from the data related to air conditioning systems, and the narrative produced by the generative comparison model 136 can include the trend.

As noted above, the generative AI application 130 and, more specifically, the optimization model 134 can be communicatively coupled to other data sources 150, such as a proprietary database 156. Step S700 may also include searching or otherwise obtaining from the proprietary database 156 selection criteria training data. This selection criteria training data can include selection strategies of the competitor, selection strategies of the proprietor, or both.

Using selection criteria training data obtained as discussed above, the optimization model 134 can be trained to identify at least one of the selection strategies of the proprietor or the selection strategies of the competitor using strategy training data.

As noted above, the application model 132, the optimization model 134, and the generative comparison model 136 are AI-based models and, more specifically, ML-based models. Although an ML-based model is described, other AI-models can be used. The ML-based model can be an artificial neural network, but other ML-based models can also be used, such as linear models, for example. These ML-based models can be trained using various methods including, for example, decision trees, support vector machines, Naïve Bayes classifier, k-means clustering, deep neural networks, sequential Bayesian filtering, or combinations thereof. These ML-based models can be generated using supervised, unsupervised, or semi-supervised learning algorithms. Reinforcement learning or deep reinforcement learning can be used, such as when the training database is a large data set. In some embodiments, the ML-based model draws an inference from the training data and this inference can be evaluated, such as feedback provided to the model in terms of a correct inference or an incorrect inference, for example.

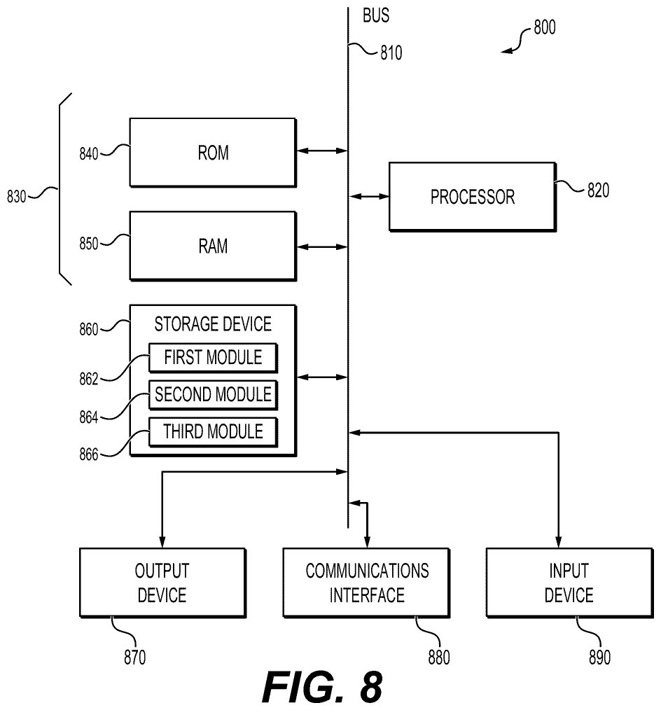

FIG. 8 shows a computing device 800 (or computing system) that may be used to implement the air conditioning selection system 100 discussed herein. The computing device 800 shown in FIG. 8 includes a processing unit. The processing unit can be a central processing unit or a processor 820. The computing device 800 also includes a system bus 810 that couples various system components including system memory 830, such as read-only memory (ROM) 840 and random-access memory (RAM) 850, to the processor 820. The computing device 800 can include a cache of high-speed memory connected directly with, in close proximity to, or integrated as part of the processor 820. The computing device 800 copies data from the system memory 830 and/or a storage device 860 to the cache for quick access by the processor 820. In this way, the cache provides a performance boost that avoids processor 820 delays while waiting for data. These and other modules can control or be configured to control the processor 820 to perform various actions. The system memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any processor and a hardware module or software module, such as a first module 862, a second module 864, and a third module 866 stored in the storage device 860, configured to control the processor 820, as well as a special-purpose processor where software instructions are incorporated into the actual processor design. The generative AI application 130 and the selection module 140 are examples of modules. The processor 820 essentially can be a completely self-contained computing system, containing multiple cores or processors, a bus, memory controller, cache, etc. A multi-core processor can be symmetric or asymmetric.

The system bus 810 may be any of several types of bus structures, including a memory bus or memory controller, a peripheral bus, and a local bus using any of a variety of bus architectures. A basic input/output (BIOS) stored in ROM 840 or the like may provide the basic routine that helps to transfer information between elements within the computing device 800, such as during start-up. The computing device 800 further includes storage devices 860 such as a hard disk drive, a magnetic disk drive, an optical disk drive, a tape drive, or the like. As noted above, the storage device 860 can include software modules 862, 864, 866 for controlling the processor 820. Other hardware or software modules are contemplated. The storage device 860 is connected to the system bus 810 by a drive interface. The drives and the associated computer-readable storage media provide nonvolatile storage of computer-readable instructions, data structures, program modules, and other data for the computing device 800. In one aspect, a hardware module that performs a particular function includes the software component stored in a tangible computer-readable storage medium in connection with the necessary hardware components, such as the processor 820, the system bus 810, an output device 870, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 800 is a small, handheld computing device, a desktop computer, or a computer server.

Although the exemplary embodiment described herein employs a hard disk as the storage device 860, other types of computer-readable media which can store data that are accessible by a computer, such as magnetic cassettes, flash memory cards, digital versatile disks, cartridges, random access memories (RAMs) 850, and read-only memories (ROMs) 840, or data streams may also be used in the exemplary operating environment. Tangible computer-readable storage media, computer-readable storage devices, or computer-readable memory devices expressly exclude media such as transitory waves, energy, carrier signals, electromagnetic waves, and signals per se.

To enable user interaction with the computing device 800, an input device 890 represents any number of input mechanisms, such as a microphone for speech, a touch-sensitive screen for gesture or graphical input, a keyboard, a mouse, and so forth. An output device 870 can also be one or more of a number of output devices including printers and displays (e.g., the display 115 discussed above). In some instances, multimodal systems enable a user to provide multiple types of input to communicate with the computing device 800. The communications interface 880 generally governs and manages the user input and system output, including the various communications interfaces discussed above. There is no restriction on operating on any particular hardware arrangement, and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Various components of the air conditioning selection system 100 are communicatively coupled, and these components may be communicatively coupled to each other using any suitable means. Where the components are part of the same computing device, they may be communicatively coupled to each other using the system bus 810, as discussed above. Where such components are separate from each other, the components may be communicatively coupled to each other using other connections, such as wired connections or wireless connections. Suitable connections include, for example, an electrical conductor, a low-level serial data connection, such as Recommended Standard (RS) 232 or RS-485, a high-level serial data connection, such as Universal Serial Bus (USB) or the Institute of Electrical and Electronics Engineers (IEEE) 1394, a parallel data connection, such as IEEE 1284 or IEEE 488, and/or a short-range wireless communication channel, such as BLUETOOTH, and/or wireless communication networks using radio frequency signals, such as Wi-Fi. When a wired connection and protocol are used, each of the components may include a suitable port to support the wired connection. When a wireless protocol is used, each of the components may include a transmitter and/or a receiver.

As noted above, the systems and methods discussed herein can be used to select suitable air conditioning systems for a particular application and identify various advantages and disadvantages of such systems, and then present the selected systems and the various advantages and disadvantages to an individual, such as the owner or operator. In some embodiments, the systems and methods discussed herein make use of AI-based models, such as ML-based models. As evidenced from the discussion above, there are multiple different systems that can be considered and many different inputs and factors for selecting one or more suitable air conditioning system. Among the advantages provided by the systems and methods discussed herein, particularly those implementing the AI-based models, is that the considerations and variables discussed above can be optimized in multiple dimensions, simultaneously, avoiding sub-optimizations, which can result when these factors are taken one step at a time. Moreover, the selection approach can be taken in a common and automated data handling approach, avoiding inconsistent selections or omissions of analysis considerations in this multivariate analysis.

Although this invention has been described with respect to certain specific exemplary embodiments, many additional modifications and variations will be apparent to those skilled in the art in light of this disclosure. It is therefore to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. A method of selecting an air conditioning system, the method being a computer-implemented method executed by one or more processors, the method comprising:
receiving a plurality of usage inputs including an application, an application size, and an air parameter;
determining, using an application model, a plurality of input air conditions and a plurality of output air conditions for the application based on the plurality of usage inputs, the application model being an artificial-intelligence-based model;
calculating, using a selection module, system parameters for a plurality of different air conditioning systems;
selecting, using an optimization model, at least one air conditioning system from the plurality of different air conditioning systems, the optimization model selecting the at least one air conditioning system using the system parameters for the plurality of different air conditioning systems based on one or more optimization targets, the optimization model being an artificial-intelligence-based model; and
outputting results reflecting the selected at least one air conditioning system.

2. The method of claim 1, wherein the application model, the optimization model, or both is a machine-learning-based model.

3. The method of claim 1, wherein the system parameters includes air conditioning system size and resource requirements.

4. The method of claim 3, wherein the resource requirements includes energy requirements.

5. The method of claim 1, wherein the air parameter is a location of the application.

6. The method of claim 1, wherein selecting the at least one air conditioning system includes selecting two or more air conditioning systems from the plurality of different air conditioning systems using the optimization model, the optimization model selecting the two or more air conditioning systems from the plurality of different air conditioning systems using the system parameters for the plurality of different air conditioning systems based on the one or more optimization targets,
wherein the method further comprises generating, using a generative comparison model, a narrative comparing the selected two or more air conditioning systems, the generative comparison model being an artificial-intelligence-based model, and
wherein outputting the results includes outputting the two or more air conditioning systems with the narrative.

7. The method of claim 6, wherein the generative comparison model is a machine-learning-based model.

8. The method of claim 6, wherein the narrative compares an upfront cost to procure and install each of the two or more air conditioning systems.

9. The method of claim 6, wherein the narrative compares a total cost of ownership of each of the two or more air conditioning systems.

10. The method of claim 9, wherein the system parameters include air conditioning system size and resource requirements, and the total cost of ownership of each of the two or more air conditioning systems is based on the resource requirements.

11. The method of claim 6, wherein one of the two or more air conditioning systems is an air conditioning system of a proprietor, and another one of the two or more air conditioning systems is an air conditioning system of a competitor.

12. The method of claim 11, wherein the generative comparison model is trained to generate a narrative providing benefits of the air conditioning system of the proprietor relative to the air conditioning system of the competitor.

13. The method of claim 12, further comprising retraining the optimization model, the generative comparison model, or both by searching one or more data sources for air conditioning system selection strategies of the competitor.

14. The method of claim 13, wherein the optimization model, the generative comparison model, or both is communicatively coupled to an internal database, the internal database being one of the one or more data sources for air conditioning system selection strategies of the competitor.

15. The method of claim 13, wherein the optimization model, the generative comparison model, or both is communicatively coupled to the internet, the optimization model, the generative comparison model, or both using publicly available data via the internet as one of the one or more data sources for air conditioning system selection strategies of the competitor.

16. The method of claim 6, wherein the optimization model, the generative comparison model, or both is communicatively coupled to the internet, and
wherein the method further comprises searching one or more data sources via the internet for data related to air conditioning systems and retraining the optimization model, the generative comparison model, or both using the data related to air conditioning systems.

17. The method of claim 16, wherein the data related to air conditioning systems includes regulatory data.

18. The method of claim 16, wherein the narrative comparing the selected two or more air conditioning systems includes a trend derived from the data related to air conditioning systems.

19. A method of generating an application model for selecting an air conditioning system, the method comprising:
receiving training data comprising a plurality of applications, each application of the plurality of applications having an application size, an output air parameter, and at least one of a plurality of input air conditions or a plurality of output air conditions; and
training the application model using the training data to correlate the application, the application size, the input air parameter, and the output air parameter, with the at least one of the plurality of input air conditions or the plurality of output air conditions, the application model being an artificial-intelligence-based model.

20. The method of claim 19, wherein the application model is a machine-learning-based model.

21. The method of claim 19, wherein the training data further comprises a plurality of locations and temperature and humidity data at each one of the plurality of locations.

22. A method of generating an optimization model for selecting an air conditioning system, the method comprising:
receiving training data comprising an air conditioning system size and resource requirements for a plurality of different air conditioning systems; and
training the optimization model using the training data to select two or more air conditioning systems from the plurality of different air conditioning systems using the air conditioning system size and resource requirements based on one or more optimization targets, the optimization model being an artificial-intelligence-based model.

23. The method of claim 22, wherein the optimization model is a machine-learning-based model.

24. The method of claim 22, wherein one of the two or more air conditioning systems is an air conditioning system of a proprietor and another one of the two or more air conditioning systems is an air conditioning system of a competitor.

25. The method of claim 24, further comprising defining the one or more optimization targets based on selection strategies of the proprietor, selection strategies of the competitor, or both.

26. The method of claim 25, further comprising training the optimization model to identify at least one of the selection strategies of the proprietor or the selection strategies of the competitor using strategy training data.

27. The method of claim 26, wherein training the optimization model to identify at least one of the selection strategies of the competitor includes searching one or more data sources via the internet for data related to air conditioning systems, the strategy training data including the data related to air conditioning systems.
